(19) United States
(12) Patent Application Publication
(10) Pub. No.: US 2005/0248269 A1
(43) Pub. Date: Nov. 10, 2005

(54) Metal halide lamp

(75) Inventors: Karst Vaartjes, Eindhoven (NL); Marco Haverlag, Eindhoven (NL); Josephus Chirstiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,135

(22) PCT Filed: Jun. 17, 2003
(86) PCT No.: PCT/IB03/02744

§ 371 Date: Jan. 12, 2005

(30) Foreign Application Priority Data
Jul. 17, 2002 (EP) 02077896.5

(51) Int. Cl. H01J 63/04; H01J 1/62

(52) U.S. Cl. 313/510

(57) ABSTRACT

A metal halide lamp comprising a substantially cylindrical discharge vessel having an internal diameter Di<2.0 mm and filled with an ionizable filling, wherein two electrodes are present at a mutual distance EA for maintaining a discharge in the discharge vessel, wherein the filling comprises an inert gas, such as Xe, having a pressure at room temperature between 5 and 25 bar, and an ionizable salt, characterized in that said ionizable salt is selected from the group comprising PrI3, NdI3 and LuI3.

The invention relates to an automotive metal halide lamp comprising a substantially cylindrical discharge vessel having an internal diameter Di<2.0 mm, and filled with an ionizable filling, wherein two electrodes are present at a mutual distance EA, wherein preferably 3 mm<EA<7 mm, for maintaining a discharge in the discharge vessel, and wherein the filling comprises an inert gas such as Xe having a pressure at room temperature between 5 and 25 bar, and an ionizable salt.

Such a lamp is described in the international patent application WO 00/67294. Many modern automotive metal halide lamps have a very small, very high pressure discharge vessel surrounded by a gas-filled outer bulb, and have a lamp power between 20 W and 40 W. The filling of the lamp can contain Hg, or alternatively can be mercury-free and contain Zn or ZnI₂. Such lamps require highly efficient ionizable salts, and it is known to use a salt mixture of NaI and CeI₃. Such a lamp is based on the recognition that a high efficacy and a sufficiently high color rendering is possible when sodium halide is used as a filling ingredient of a lamp and a strong widening and inversion of the Na emission in the Na-D lines takes place during lamp operation. This requires a high coldest-spot temperature in the discharge vessel, which excludes under practical conditions the use of quartz or quartz glass for the discharge vessel wall and renders the use of a ceramic material for the discharge vessel wall preferable. The term “ceramic wall” in the present description and claims is understood to cover a wall of metal oxide such as, for example, sapphire or densely sintered polycrystalline Al₂O₃, as well as metal nitride, for example AlN. The known lamp combines a good color rendering with a comparatively wide range of the color temperature.

The lamp has the advantage that the discharge vessel has very compact dimensions which render the lamp highly suitable for use in a headlamp for a motor vehicle. Owing to the small internal diameter in comparison with the electrode spacing, and thus the discharge arc length, the discharge arc is hemmed in by the discharge vessel wall, so that the discharge arc has a sufficiently straight shape for it to be suitable for use as a light source for a motor vehicle headlamp. A small internal diameter Di is found to be of essential importance for realizing a sharp beam delineation necessary for use in motor vehicles in combination with a small spot of high brightness immediately adjacent this delineation. Such very small internal diameter renders the lamp particularly suitable for use as a light source in a complex-shape headlamp. An advantage of such a headlamp is that no separate passing-beam cap is required in the formation of the light beam to be generated in order to realize a sufficiently sharp beam delineation.

The drawbacks of the known lamp are however a relatively low correlated color temperature (CCT) (between 3000 and 3500 K), a relatively unstable luminous flux, a relatively unstable wall temperature, a relatively large initial color point spread and a relatively large color point shift during life time, mainly due to chemical transport and segregation of the NaI/CeI₃ salt mix.

The object of the invention is an automotive metal halide lamp wherein one or more of the above-mentioned drawbacks are alleviated. In order to achieve that goal, said ionizable salt is selected from the group comprising PrI₃, NdI₃ and LuI₃. Preferably said ionizable salt further comprises NaI, wherein the molar ratio NaI/(PrI₃+NdI₃+LuI₃) lies between 1.0 and 10.3. Although usually one of the above-mentioned rare earth iodides will be used, it is possible to use a mixture as well. It was found that in a lamp of the above-mentioned properties these salts are only slightly sensitive to big variations in lamp power and thus in coldest spot temperature, while showing a color spot close to the BBL (“black body line”), and that these salts are relatively insensitive to color shifts due to segregation, i.e. changes in the salt mix ratio at the coldest spot position of the lamp due to for instance corrosion or transport of the liquid salt. In particular the use of PrI₃ results in an excellent color temperature for automotive purposes, close to the preferred CCT of 4200 K, while if LuI₃ is used for instance the color temperature can be enhanced by adding small amounts of TbI₃ and/or GdI₃.

In a first preferred embodiment the molar ratio NaI/PrI₃ lies between 2.3 and 10.3, preferably between 3.0 and 5.7, and more preferably is approximately 3.5. Preferably the amount of PrI₃ in the discharge vessel is between 10 and 335 μmol/cm³, more preferably between 25 and 160 μmol/cm³, still more preferably approximately 50 μmol/cm³. In a discharge vessel of 1.6 mm×8 mm (Di×EA) this results in a CCT of approximately 4200 K. In a discharge vessel of 1.2 mm×6 mm the preferred concentration is 1.8 times higher in order to have the same CCT.

In a second preferred embodiment the molar ratio NaI/NdI₃ lies between 3 and 6.7, preferably between 3.6 and 4.8, and more preferably is approximately 4.2. Preferably the amount of NdI₃ in the discharge vessel is between 8 and 301 μmol/cm³, more preferably between 30 and 167 μmol/cm³, still more preferably approximately 45 μmol/cm³. In a discharge vessel of 1.6 mm×8 mm (Di×EA) this results in a CCT of approximately 4200 K. In a discharge vessel of 1.2 mm×6 mm the preferred concentration is 1.8 times higher in order to have the same CCT.

In a third preferred embodiment the molar ratio NaI/LuI₃ lies between 1.0 and 3.2, preferably between 1.2 and 1.8, and more preferably is approximately 1.4. Preferably the amount of LuI₃ in the discharge vessel is between 15 and 414 μmol/cm³, more preferably between 27 and 230 μmol/cm³, still more preferably approximately 69 μmol/cm³. In a discharge vessel of 1.6 mm×8 mm (Di×EA) this results in a CCT of approximately 4200 K. In a discharge vessel of 1.2 mm×6 mm the preferred concentration is 1.8 times higher in order to have the same CCT.

These and other aspects of the lamp according to the invention will be explained in more detail with reference to the drawings (not to scale), wherein:

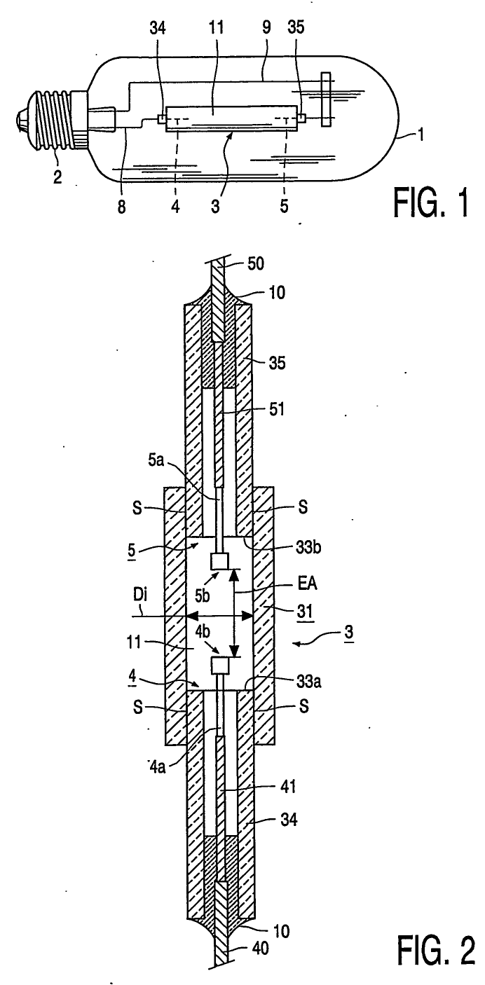

FIG. 1 diagrammatically shows a lamp according to the invention; and

FIG. 2 shows the discharge vessel of the lamp of FIG. 1 in detail.

FIG. 1 shows a metal halide lamp provided with a discharge vessel 3 having a ceramic wall which encloses a discharge space 11 containing an ionizable filling. Two tungsten electrodes 4, 5 whose tips 4b, 5b are at a mutual distance EA are arranged in the discharge space, and the discharge vessel has an internal diameter Di at least over the distance EA. The discharge vessel is closed at one side by means of a ceramic projecting plug 34, 35 which encloses a current lead-through conductor (FIG. 2: 40, 41, 50, 51) to an electrode 4, 5 positioned in the discharge vessel with a narrow intervening space and is connected to this conductor in a gastight manner by means of a melting-ceramic joint (FIG. 2: 10) at an end remote from the discharge space. The discharge vessel is surrounded by an outer bulb 1 which is provided with a lamp cap 2 at one end. A discharge will extend between the electrodes 4, 5 when the lamp is operating. The electrode 4 is connected to a first electrical contact forming part of the lamp cap 2 via a current conductor 8. The electrode 5 is connected to a second electrical contact forming part of the lamp cap 2 via a current conductor 9. The discharge vessel, shown in more detail in FIG. 2 (not to scale), has a ceramic wall and is formed from a cylindrical part with an internal diameter Di which is bounded at either end by a respective ceramic projecting plug 34, 35 which is fastened in a gastight manner in the cylindrical part by means of a sintered joint S. The ceramic projecting plugs 34, 35 each narrowly enclose a current lead-through conductor 40, 41, 50, 51 of a relevant electrode 4, 5 having a tip 4b, 5b. The current lead-through conductor is connected to the ceramic projecting plug 34, 35 in a gastight manner by means of a melting-ceramic joint 10 at the side remote from the discharge space. The electrode tips 4b, 5b are arranged at a mutual distance EA. The current lead-through conductors each comprise a halide-resistant portion 41, 51, for example in the form of a Mo—Al₂O₃ cermet and a portion 40, 50 which is fastened to a respective end plug 34, 35 in a gas tight manner by means of the melting-ceramic joint 10. The melting-ceramic joint extends over some distance, for example approximately 1 mm, over the Mo cermet 40, 41. It is possible for the parts 41, 51 to be formed in an alternative manner instead of from a Mo—Al²O³ cermet. Other possible constructions are known, for example, from EP 0 587 238. A particularly suitable construction was found to be a halide-resistant coil applied around a pin of the same material. Mo is very suitable for use as a highly halide-resistant material. The parts 40, 50 are made from a metal whose coefficient of expansion corresponds very well to that of the end plugs. Nb, for example, is a highly suitable material for this purpose. The parts 40, 50 are connected to the current conductors 8, 9 in a manner not shown in any detail. The lead-through construction described renders it possible to operate the lamp in any desired burning position. Each of the electrodes 4, 5 comprises an electrode rod 4a, 5a which is provided with a tip 4b, 5b.

In a practical embodiment of the lamp as represented in the drawing, a number of lamps were manufactured with a rated power of 26 W each. The lamps are suitable for use as headlamps for a motor vehicle. The ionizable filling of the discharge vessel 3 of each individual lamp comprises 30 mg/cm³ Hg and 25 mg/cm³ iodide, comprising NaI and a rare earth iodide chosen from the group consisting of PrI₃, NdI₃ and LuI₃. In a mercury-free embodiment Hg may be replaced by Zn or ZnI₂. The filling further comprises Xe with a filling pressure at room temperature of 8 bar. The distance between the electrode tips 4a, 5a EA is 5 mm, the internal diameter Di is 1.4 mm, so that the ratio EA/Di=3.6. The wall thickness of the discharge vessel 3 is 0.3 mm.

In a first embodiment the rare earth iodide is PrI₃ at approximately 50 μmol/cm³, and the molar ratio NaI/PrI₃ is approximately 3.5.

In a second embodiment the rare earth iodide is NdI₃ at 45 μmol/cm³, and the molar ratio NaI/NdI₃ is approximately 4.2.

In a third embodiment the rare earth iodide is LuI₃ at 69 μmol/cm³, and the molar ratio NaI/LuI₃ is approximately 1.4. In order to improve the color temperature of this lamp, small amounts of TbI₃ or GdI₃ were added.

The lamps described showed excellent color temperature and color stability properties compared to NaI/CeI₃ fillings, while the efficacy is only slightly lower.

1. A metal halide lamp comprising a substantially cylindrical discharge vessel (3) having an internal diameter Di<2.0 mm and filled with an ionizable filling, wherein two electrodes are present at a mutual distance EA for maintaining a discharge in the discharge vessel, wherein the filling comprises an inert gas such as Xe having a pressure at room temperature between 5 and 25 bar, and an ionizable salt, characterized in that said ionizable salt is selected from the group comprising PrI₃, NdI₃ and LuI₃.

2. A lamp according to claim 1, wherein said ionizable salt further comprises NaI, and wherein the molar ratio NaI/(PrI₃+NdI₃+LuI₃) lies between 1.0 and 10.3.

3. A lamp according to claim 2, wherein the molar ratio NaI/PrI₃ lies between 2.3 and 10.3, preferably between 3.0 and 5.7, and more preferably is approximately 3.5.

4. A lamp according to claim 1, wherein the amount of PrI₃ in the discharge vessel is between 10 and 335 μmol/cm³, preferably between 25 and 160 μmol/cm³, more preferably approximately 50 μmol/cm³.

5. A lamp according to claim 2, wherein the molar ratio NaI/NdI₃ lies between 3.0 and 6.7, preferably between 3.6 and 4.8, and more preferably is approximately 4.2.

6. A lamp according to claim 1, wherein the amount of NdI₃ in the discharge vessel is between 8 and 301 μmol/cm³, preferably between 30 and 167 μmol/cm³, more preferably approximately 45 μmol/cm³.

7. A lamp according to claim 2, wherein the molar ratio NaI/LuI₃ lies between 1.0 and 3.2, preferably between 1.2 and 1.8, and more preferably is approximately 1.4.

8. A lamp according to claim 1, wherein the amount of LuI₃ in the discharge vessel is between 15 and 414 μmol/cm³, preferably between 27 and 230 μmol/cm³, more preferably approximately 69 μmol/cm³.

9. A lamp according to claim 1, wherein Di<1.5 mm.

10. A lamp according to claim 1, wherein EA lies between 3 mm and 7 mm.

11. A lamp according to claim 1, wherein the discharge vessel has a ceramic wall.

12. A lamp according to claim 1, wherein the discharge vessel is surrounded by a gas-filled outer bulb.

13. A lamp according to claim 1, wherein the lamp power lies between 20 W and 40 W.
